(19) United States
(12) Patent Application Publication
(10) Pub. No.: US 2016/0072562 A1
(43) Pub. Date: Mar. 10, 2016

(54) CHANNEL STATE INFORMATION REPORTING WITH BASIS EXPANSION FOR ADVANCED WIRELESS COMMUNICATIONS SYSTEMS

(71) Applicant: Samsung Electronics Co., Ltd., Suwon-si (KR)

(72) Inventors: Eko Onggosanusi, Allen, TX (US); Yang Li, Plano, TX (US); Young Han Nam, Plano, TX (US); Md Saifur Rahman, Richardson, TX (US)

(21) Appl. No.: 14/593,711

(22) Filed: Jan. 9, 2015

Related U.S. Application Data
(60) Provisional application No. 62/048,729, filed on Sep. 10, 2014.
(60) Provisional application No. 62/059,664, filed on Oct. 3, 2014.

(51) Int. Cl. H04B 7/04; H04B 7/06

(52) U.S. Cl. CPC H04B 7/0417; H04B 7/0626

(57) ABSTRACT

Scalable channel state information feedback for FD-MIMO involves quantizing the downlink channel according to a finite set of basis vectors to reduce the number of coefficients quantized and reported from a user equipment to a base station. The procedure includes measurement at the base station of angle of arrival spread for uplink signal reception from the user equipment and signaling that spread to the user equipment. The user equipment then quantizes the MIMO channel according to a sub-scheme configured based upon the signaled spread and reports (feeds back) the quantized channel to the base station.

This application claims priority to and hereby incorporates by reference U.S. Provisional Patent Application No. 62/048,729, filed Sep. 10, 2014, entitled “CHANNEL STATE INFORMATION REPORTING WITH BASIS EXPANSION FOR ADVANCED WIRELESS COMMUNICATION SYSTEMS” and U.S. Provisional Patent Application No. 62/059,664, filed Oct. 3, 2014, entitled “CODEBOOK DESIGN AND FEEDBACK PROCEDURES FOR ADVANCED WIRELESS COMMUNICATION SYSTEMS.”

### TECHNICAL FIELD

The present disclosure relates generally to reporting channel state information in a wireless communication system and, more specifically, to reporting channel state information associated with multiple transmit antennas. Such two dimensional arrays are associated with a type of multiple-input-multiple-output (MIMO) system often termed “full-dimension” MIMO (FD-MIMO).

### BACKGROUND

Existing channel quality reporting processes in wireless communications systems do not sufficiently accommodate reporting of channel state information associated with large, two dimensional array transmit antennas.

There is, therefore, a need in the art for improved channel quality reporting in wireless communications systems.

### SUMMARY

Scalable channel state information feedback for FD-MIMO involves quantizing the downlink channel according to a finite set of basis vectors to reduce the number of coefficients quantized and reported from a user equipment to a base station. The procedure includes measurement at the base station of angle of arrival spread for uplink signal reception from the user equipment and signaling that spread to the user equipment. The user equipment then quantizes the MIMO channel according to a sub-scheme configured based upon the signaled spread and reports (feeds back) the quantized channel to the base station.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, where such a device, system or part may be implemented in hardware that is programmable by firmware or software. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a portion of an advanced wireless communication system within which channel state information reporting with basis expansion may be implemented in accordance with various embodiments of the present disclosure;

FIG. 1A represents an exemplary antenna array within the wireless communication system of FIG. 1;

FIG. 2 illustrates the subset of elevation dimensions for channel state information reporting with basis expansion in accordance with various embodiments of the present disclosure, where a similar visualization applied to azimuthal dimensions;

FIG. 3 illustrates a coordinate system for use in connection with channel state information reporting with basis expansion in accordance with various embodiments of the present disclosure;

FIG. 4 illustrates an exemplary scalar codebook for use in connection with channel state information reporting with basis expansion in accordance with various embodiments of the present disclosure;

FIG. 5 illustrates an exemplary 2D codebook for use in connection with channel state information reporting with basis expansion in accordance with various embodiments of the present disclosure;

FIG. 6 illustrates data sets employed for training-based construction of codebooks for use in connection with channel state information reporting with basis expansion in accordance with various embodiments of the present disclosure; and

FIGS. 7A and 7B illustrate two exemplary operations for overall transmit-receive operations at the eNB and the UE in accordance with one embodiment of the present disclosure.

### DETAILED DESCRIPTION

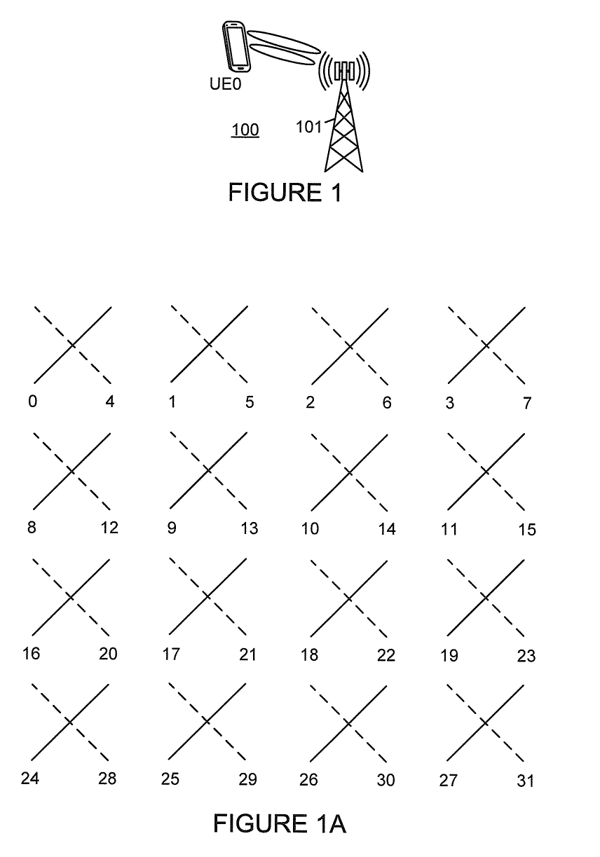

FIGS. 1 through 7B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The following documents are hereby incorporated herein by reference: [REF1] 3GPP TS36.211; [REF2] 3GPP TS36.212; and [REF3] 3GPP TS36.213.

### LIST OF ACRONYMS

2D: two-dimensional

MIMO: multiple-input-multiple-output

SU-MIMO: single-user MIMO

MU-MIMO: multi-user MIMO

3GPP: 3rd generation partnership project

LTE: long-term evolution

UE: user equipment

eNB: evolved Node B or “eNodeB”

DL: downlink

UL: uplink

CRS: cell-specific reference signal(s)

DMRS: demodulation reference signal(s)

SRS: sounding reference signal(s)

UE-RS: UE-specific reference signal(s)

CSI-RS: channel state information reference signals

SCID: scrambling identity

MCS: modulation and coding scheme

RE: resource element

CQI: channel quality information

PMI: precoding matrix indicator

RI: rank indicator

MU-CQI: multi-user CQI

CSI: channel state information

CSI-IM: CSI interference measurement

CoMP: coordinated multi-point

DCI: downlink control information

UCI: uplink control information

PDSCH: physical downlink shared channel

PDCCH: physical downlink control channel

PUSCH: physical uplink shared channel

PUCCH: physical uplink control channel

PRB: physical resource block

RRC: radio resource control

AoA: angle of arrival

AoD: angle of departure

The need for high-performance, scalable (with respect to the number and geometry of transmit antennas), and flexible CSI feedback framework and structure for LTE enhancements when FD-MIMO (the use of large two-dimensional antenna arrays) is supported. To achieve high performance, more accurate CSI (in terms of quantized MIMO channel) is needed at the eNB, especially for FDD scenarios. In this case, the precoding framework (PMI-based feedback) of previous LTE (e.g. Rel.12) may need to be replaced. However, feeding back the quantized channel coefficients may be excessive in terms of feedback requirements. In this disclosure, the following properties of FD-MIMO are factored in for the proposed alternative feedback schemes:
The use of closely spaced large 2D antenna arrays (primarily geared toward high beamforming gain rather than spatial multiplexing) along with relatively small angular spread for each UE: This allows “compression” or “dimensionality reduction” of the quantized channel feedback based on a fixed set of basis functions/vectors.
Low mobility as the target scenario for FD-MIMO: Possibility to update channel quantization parameters (such as the channel angular spreads) at a low rate, e.g. using UE-specific higher-layer signaling. In addition, CSI feedback can also be performed cumulatively.

In the present disclosure, a scalable and FDD-enabling CSI feedback scheme for FD-MIMO is described where the downlink channel is quantized according to a finite set of basis functions/vectors to reduce the number of coefficients that need to be quantized and reported from a UE to the eNB. The high-level procedure of the proposed scheme is as follows (assuming the use of 2D antenna array):
From reception of at least one UL signal (e.g., UL-SRS, UL-DMRS), the eNB measures an associated UL AoA spread associated with each UE, denoted as [θₘᵢₙ, θₘₐₓ] and/or [φₘᵢₙ, φₘₐₓ] in the elevation (zenith) and/or azimuthal dimensions, respectively. These parameters for (or, in general, are parts of) a UL AoA profile associated with that particular UE.
   The acquired AoA values (θₘᵢₙ, θₘₐₓ, φₘᵢₙ, φₘₐₓ) or profile are signaled to the UE via a UE-specific medium such as higher-layer RRC signaling or dynamic-BCH (D-BCH). Some other parameters may be signaled as well. These configuration parameters are associated with the choice of channel quantization sub-scheme (corresponding to a reduced subset of basis functions/vectors).
Upon receiving configuration parameter(s), the UE quantizes the MIMO channel according to the configured sub-scheme and reports (feeds back) the quantized channel to the eNB via an uplink channel.
The three steps listed above are repeated whenever the eNB updates the configuration parameters.

The proposed CSI feedback upgrade is intrusive as it requires some significant amount of additional standardization. It is a considerable departure from the Rel.12 LTE CSI feedback paradigm. However, as the size of antenna array increases, such an evolution path is eventually inevitable if high-performance FD-MIMO is a goal of the future evolution of LTE—especially in FDD scenarios.

Advantages of the approach described in the present disclosure include overhead reduction from quantizing coefficients to a significantly smaller number through subspace reduction, compared to direct channel quantization, as described above. It is also possible to derive the basis functions/vectors at the UE using, e.g., eigen-vector decomposition (EVD) or singular-value decomposition (SVD) and feed them back to the eNB. However, EVD/SVD precoders are known to be sensitive to error (which results in unintentional signal space cancellation) even when regularization is employed. In this sense, a fixed set of basis functions/vectors tends to be more robust.

FIG. 1 illustrates a portion of an advanced wireless communication system within which CSI reporting with basis expansion may be implemented in accordance with various embodiments of the present disclosure. The wireless communication system 100 includes at least one base station (BS) 101 (also sometimes referred to as “NodeB,” “evolved NodeB” or “eNB”), and generally a plurality of base stations (not shown). User equipment UE0 (also sometimes referred to as a “mobile station” or “MS”) communicates wirelessly with the base station 101. In the exemplary embodiment, at least one of the base station 101 and the user equipment UE0 includes an antenna array as described below. Each of the base station 101 and the user equipment UE0 includes a processor (or programmable controller or the like) coupled to a wireless transceiver and configured to control transmission and reception of signals via the transceiver, as well as to perform various functions associated with preparing signals for transmission and/or processing received signals, such as demodulation, decoding, etc. The wireless transceivers of each of base station 101 and user equipment UE0 are coupled to an antenna, which for at least base station 101 (and possibly also user equipment UE0) is an antenna array.

FIG. 1A represents an exemplary two dimensional (2D) antenna array constructed from 16 dual-polarized antenna elements arranged in a 4×4 rectangular format. In this example, each labelled antenna element is logically mapped onto a single antenna port. In general, one antenna port may correspond to multiple antenna elements (physical antennas) combined via a virtualization scheme. The 4×4 dual polarized array represented in FIG. 1A can then be viewed as 16×2=32-element array of antenna elements. The vertical dimension (consisting of 4 rows) facilitates elevation beamforming, and is in addition to the azimuthal beamforming across the horizontal dimension (consisting of 4 columns of dual polarized antennas). MIMO precoding in Rel.12 LTE standardization (per TS36.211 section 6.3.4.2, 6.3.4.4, and TS36.213 section 7.2.4) was largely designed to offer precoding gain for one-dimensional antenna array. While fixed beamforming (i.e., antenna virtualization) can be implemented across the elevation dimension, it is unable to reap the potential gain offered by the spatial and frequency selective nature of the channel.

In Rel.12 LTE, MIMO precoding (for spatial multiplexing) can be performed either with CRS (cf. TS36.211 section 6.3.4.2) or UE-RS (cf. TS36.211 section 6.3.4.4). In either case, each UE operating in spatial multiplexing mode(s) is configured to report CSI which may contain PMI (i.e. precoding codebook index). PMI report is derived from one of the following sets of standardized codebooks:
Two antenna ports: {TS36.211 table 6.3.4.2.3-1}
Four antenna ports: {TS36.211 table 6.3.4.2.3-2} or {TS36.213 table 7.2.4-0A, B, C, and D}
Eight antenna ports: {TS36.213 table 7.2.4-1, 2, 3, 4, 5, 6, 7, and 8}
   If the eNB follows the UE's PMI recommendation, the eNB is expected to precode its transmitted signal according to the recommended precoding vector/matrix (for a given subframe and PRB). Regardless whether the eNB follows the UE's recommendation, the UE is configured to report a PMI according to the above precoding codebooks. Here a PMI (which may consist of a single index or a pair of indices) is associated with a precoding matrix W of size N_{c}×N_{L}, where N_{c} is the number of antenna ports in one row (=number of columns) and N_{L} is the number of transmission layers. As the number of antenna elements increases (e.g., up to 8 rows of four dual-polarized antennas which amounts to 64 elements), significantly larger precoding codebooks are needed. In addition, as MU-MIMO becomes a dominant scheduling strategy, obtaining a good multi-user pairing from single-user PMIs (received from the active UEs) has proved to be challenging. Hence, the Rel.12 LTE CSI feedback paradigm limits the potential of FD-MIMO especially in FDD scenarios where channel reciprocity is limited to long-term channel statistics at best.

Therefore, for FD-MIMO that utilizes 2D antenna array (hence 2D precoding), the need for high-performance, scalable (with respect to the number and geometry of transmit antennas), and flexible CSI feedback framework and structure is evident. To achieve high performance, more accurate CSI (preferably in terms of quantized MIMO channel) is needed at the eNB. This is especially the case for FDD scenarios where short-term reciprocity is infeasible. In this case, the previous LTE (e.g. Rel.12) precoding framework (PMI-based feedback) may need to be replaced. At the same time, however, feeding back the quantized channel coefficients may be excessive in terms of feedback requirements.

In this disclosure, the following properties of FD-MIMO are factored in for our proposed schemes:
The use of closely spaced large 2D antenna arrays (primarily geared toward high beamforming gain rather than spatial multiplexing) along with relatively small angular spread for each UE: This allows “compression” or “dimensionality reduction” of the quantized channel feedback. In this case, a set of basis functions/vectors is used and quantization is basically expressing the MIMO channel in terms of a linear combination of those basis functions/vectors.
Low mobility as the target scenario for FD-MIMO: This alternative exploits the possibility to update quantization parameters (long-term channel statistics such as channel angular spread) at a low rate, e.g., using UE-specific higher-layer signaling. In addition, CSI feedback can also be performed cumulatively.
While time-varying basis functions/vectors can be used (e.g., derived from EVD or SVD and fed back from the UE to the eNB), small channel angular spread warrants the use of a fixed master-set of basis functions/vectors derived primarily from the channel characteristics. For a given channel angular spread characteristic, a subset of the fixed master-set (where the master-set is pre-known both at the UE and the eNB) is chosen by the eNB and signaled to the UE.

The procedure for operating the proposed channel feedback scheme is as follows:
From the UL signal reception (in terms of, e.g., UL-SRS, UL-DMRS), the eNB measures the AoA spread associated with each UE, denoted as [θₘᵢₙ, θₘₐₓ] and/or [φₘᵢₙ, φₘₐₓ] in the elevation (zenith) and azimuthal dimensions, respectively. Here, two alternatives are possible.
   Alt1: The eNB performs AoA estimation/measurement by scanning through the entire range of AoA values. This yields a rough AoA profile which allows the eNB to estimate the range of AoAs. By reciprocity of long-term channel statistics, the range of UL AoAs represents the range of DL AoDs for a particular UE.
      This UL measurement can be performed with the same (2D) antenna array as that used for DL transmissions, or a subset of the available antenna elements.
   Alt2: Alternatively, instead of the eNB, it is possible for the UE to measure the range of AoAs (or any other feedback parameters associated with it) and reports that range to the eNB via an UL channel. This solution, however, requires an additional standardization support.
   While the above discussion assumes the use of a single angular cone of AoDs defined by f{(φ,θ): φε[φₘᵢₙ,φₘₐₓ]̂θε[θₘᵢₙ,θₘₐₓ]}, it is also possible for the eNB to configure the UE for a plurality of cones whenever appropriate.
Regardless whether Alt1 or Alt2 is chosen, the acquired/estimated DL AoD values (θₘᵢₙ, θₘₐₓ, φₘᵢₙ, φₘₐₓ), or their representation, are signaled to the UE via a UE-specific medium such as higher-layer RRC signaling or dynamic broadcast channel (D-BCH). It is also possible to utilize PDCCH (see below for further details). Some other quantization parameters may be signaled as well (see below for further details and alternatives). These configuration parameters are associated with the choice of channel quantization sub-scheme (corresponding to a reduced subset of basis functions/vectors).
Upon receiving configuration parameter(s), the UE quantizes the DL MIMO channel according to the configured sub-scheme and reports (feeds back) the quantized channel to the eNB via an uplink channel.
   The quantized DL channel coefficients can be reported to the eNB via an UL channel such as PUCCH or PUSCH. With PUCCH, a new periodic reporting mechanism may need to be defined (here, multiple PUCCH resources may be needed). With PUSCH, the existing aperiodic PUSCH-based reporting can be utilized where the eNB triggers the UE to report quantized DL channel coefficients via a UL grant.
   The configured sub-scheme is based on a subset of basis functions/vectors chosen from the master-set, based on the channel representation parameters (see below for further details).
   For the 2D antenna array (in case of FD-MIMO), the quantization of the channel matrix H^{(q,f)} associated with each polarization (+45° or −45°), the q-th receive antenna (at the UE), and f-th subband amounts to computing the expansion coefficients

$${\{ {c}_{k , l}^{( q , f )} \}}_{k , l}$$

relative to the basis set {A(φₖ,θₗ)}_{k,l} in equation (1). Here H^{(q,f)} is an Nᵣ×N_{c} matrix, where Nᵣ and N_{c} are the number of rows (corresponding to the azimuthal angle φ) and columns (corresponding to the elevation angle θ) in the 2D array, respectively. The numbering of antenna ports follows that in FIG. 1A.
   In some embodiments, the subset of angles {(φₖ,θₗ)}_{k,l} are chosen to cover the range of AoDs [θₘᵢₙ,θₘₐₓ] and [φₘᵢₙ,φₘₐₓ]. The Nᵣ×N_{c} matrix is the transmit antenna array response A(φₖ, θₗ) for a given pair of AoDs. In case of multiple-cone configuration, equation (1) is applied to each of the plurality of cones.

H^{(q,f)}≅Σₖ₌ₖ_{₀}^{k}^{₀}^{+K-1}Σₗ₌ₗ_{₀}^{l}^{₀}^{+L-1}c_{k,l}^{(q,f)}A(φₖ,θₗ) (1)
In some embodiments, a subset of pair of angles Ω={(φₖ, θₗ)} are chosen to represent a plurality of cones, wherein the elements of the subset are one-to-one mapped to the plurality of cones (represented by ω). The Nᵣ×N_{c} matrix is the transmit antenna array response A(φₖ, θₗ) for the subset.

H^{(q,f)}≅Σ_{(k,l)εΩ}c_{k,l}^{(q,f)}A(φₖ,θₗ) (1b)
The three steps listed above are repeated whenever the eNB updates the configuration parameters.

### EXEMPLARY EMBODIMENTS

### Choice of Basis Functions/Vectors and its Associated Signaling

### Embodiment 1

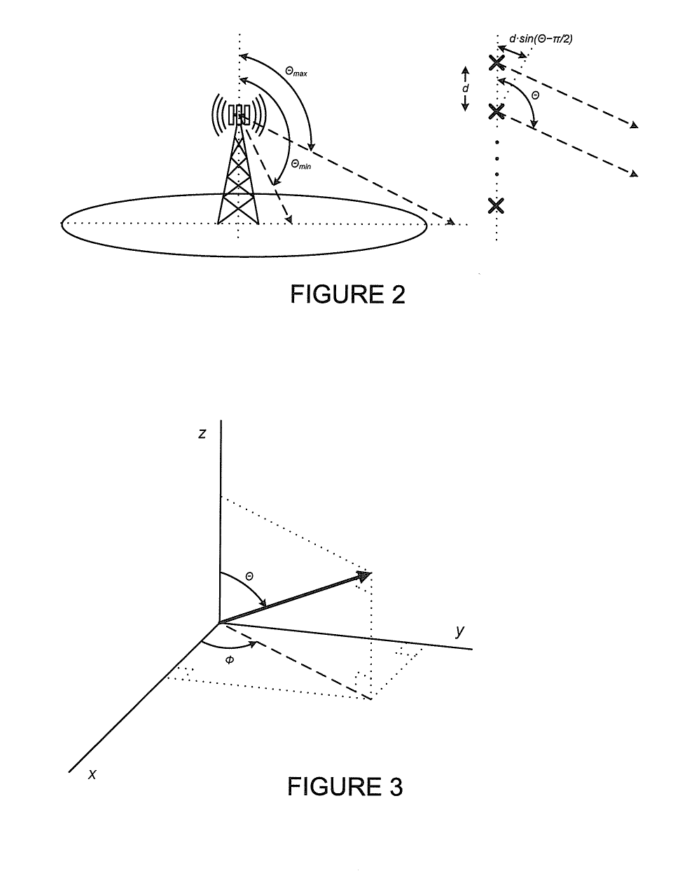

For a typical 2D dual-polarized array (see FIG. 1) with a sufficiently small inter-element spacing, for each polarization (+45° or −45°), the term A(φₖ, θₗ) can be written as follows (see FIG. 2 and FIG. 3):

$$A ( {φ}_{k} , {θ}_{l} ) = {\frac{1}{\sqrt{{N}_{r} {N}_{c}}} [ \begin{matrix}1 \\ exp ( j \frac{2 π {d}_{r} sin ( θ - π / 2 )}{λ} ) \\ ⋮ \\ exp ( j ( {N}_{r} - 1 ) \frac{2 π {d}_{r} sin ( θ - π / 2 )}{λ} )\end{matrix} ] \\ [ \begin{matrix}1 \\ exp ( j \frac{2 π {d}_{c} cos ( φ )}{λ} ) \\ ⋮ \\ exp ( j ( {N}_{c} - 1 ) \frac{2 π {d}_{c} cos ( φ )}{λ} )\end{matrix} ]}^{T} {=}^{△} {a}_{r} ( θ ) {a}_{c}^{T} ( φ ) \qquad ( 2 )$$

Assume that the number of frequency sub-bands and receive antennas at the UE are N_{F} and N_{RX}, respectively. In this case, the number of channel coefficients c_{k,l}^{(q,f)} that need to be quantized is 2KL×N_{RX}N_{F} instead of 2NᵣN_{c}×N_{RX}N_{F}. When (θₘₐₓ−θₘᵢₙ) and (φₘₐₓ−φₘᵢₙ) are relatively small, it is expected that KL<<NᵣN_{c} (which results in some savings in feedback requirements). This is because for a reasonable time span, a low-mobility UE is localized within a small angular cone of AoDs defined by {(φ,θ): φε[φₘᵢₙ,φₘₐₓ]̂ε[θₘᵢₙ, θₘₐₓ]}.

The proposed scheme operates based on a predetermined master-set of basis functions/vectors. This master-set is fixed and constructed to cover the entire range of AoD values, that is, {(φ,θ): φε[φₘᵢₙ,φₘₐₓ]̂θε[θₘᵢₙ, θₘₐₓ]}. For a given number of rows and columns (Nᵣ, N_{c}), at least Nᵣ values of θ (preferably well-spaced spanning [0, π)) and N_{c} values of φ (also preferably well-spaced spanning [0,2π)) are needed to construct a complete basis set (in multidimensional complex-valued field/space). One possible complete (and tight) master-set can be constructed from uniformly spaced AoD values corresponding to (1) and/or (2):

$${θ}_{l} = \frac{π}{{N}_{r}} l , {φ}_{k} = \frac{2 π}{{N}_{c}} k , l = 0 , 1 , … , {N}_{r} - 1 , k = 0 , 1 , … , {N}_{c} - 1 \qquad ( 3 )$$

In (3), the number of basis functions in the master-set is NᵣN_{c}. However, for various reasons it is better to have an over-complete master-set in practice, which can be constructed by oversampling the AoD dimensions. This results in a larger size of master-set. For example, with oversampling factors of Ωᵣ and Ω_{c} (integers >1), the following AoD oversampling scheme can be used to construct a master-set of size ΩᵣΩ_{c}NᵣN_{c}:

$${θ}_{l} = \frac{π}{{Ω}_{ r} {N}_{r}} l , {φ}_{k} = \frac{2 π}{{Ω }_{c} {N}_{c}} k , l = 0 , 1 , … , {Ω }_{r} {N}_{r} - 1 , k = 0 , 1 , … , {Ω }_{c} {N}_{c} - 1 \qquad ( 4 )$$

### Embodiment 2

Notice that (1) and (2) facilitate (or at least encourage) a linear discretization in the AoD domain. Alternatively, it is also possible to represent the MIMO channel as a linear combination of basis functions/vectors in the discrete Fourier transform (DFT) phase domain. That is:

$$\begin{matrix}{H}^{( q , f )} ≅ {\sum }_{k = {k}_{0}}^{{k}_{0} + K - 1} {\sum }_{l = {l}_{0}}^{{l}_{0} + L - 1} {c}_{k , l}^{( q , f )} {B}_{k , l} & ( 5 ) \\ {B}_{k , l} = {\frac{1}{\sqrt{{N}_{r} {N}_{c}}} [ \begin{matrix}1 \\ exp ( j \frac{2 π l}{{Δ}_{r} {N}_{r}} ) \\ ⋮ \\ exp ( j ( {N}_{r} - 1 ) \frac{2 π l}{{Δ}_{r} {N}_{r}} )\end{matrix} ] [ \begin{matrix}1 \\ exp ( j \frac{2 π l}{{Δ}_{c} {N}_{c}} ) \\ ⋮ \\ exp ( j ( {N}_{c} - 1 ) \frac{2 π l}{{Δ}_{c} {N}_{c}} )\end{matrix} ]}^{T} & ( 6 )\end{matrix}$$

Analogous to the first embodiment, in the case of multiple-cone configuration, equations (5) and (6) apply to each of the plurality of cones.

Similar to (4), Δᵣ and Δ_{c} in (6) are oversampling factors (integers ≧1, with 1 as a special case of non-overlapping DFT beams) which produce overlapping DFT beams. In that case, the master-set associated with (5) and (6) is given as follows:

$${B}_{k , l} = {\frac{1}{\sqrt{{N}_{r} , {N}_{c}}} [ \begin{matrix}1 \\ exp ( j \frac{2 π l}{{Δ}_{r} {N}_{r}} ) \\ ⋮ \\ exp ( j ( {N}_{r} - 1 ) \frac{2 π l}{{Δ}_{r} {N}_{r}} )\end{matrix} ] [ \begin{matrix}1 \\ exp ( j \frac{2 π l}{{Δ}_{c} {N}_{c}} ) \\ ⋮ \\ exp ( j ( {N}_{c} - 1 ) \frac{2 π l}{{Δ}_{c} {N}_{c}} )\end{matrix} ]}^{T} , \\ l = 0 , 1 , … , {Δ}_{r} {N}_{r} - 1 , k = 0 , 1 , … , {Δ}_{c} {N}_{c} - 1 \qquad ( 7 )$$

As mentioned above, oversampling factors of 1 correspond to non-overlapping beams, i.e., critically-sampled DFT vectors. Similarly, the number of channel coefficients c_{k,l}^{(q,f)} that need to be quantized is 2KL×N_{RX}N_{F} instead of 2NᵣN_{c}×N_{RX}N_{F}. When (θₘₐₓ−θₘᵢₙ) and (φₘₐₓ−φₘᵢₙ) are relatively small, it is expected that KL<<NᵣN_{c} (which results in some savings in feedback requirements).

In both embodiments 1 and 2 described above, the values {k₀, K, l₀, L} are chosen for each UE such that the small angular cone of AoDs defined by {(φ,θ): φε[φₘᵢₙ,φₘₐₓ]̂θε[θₘᵢₙ, θₘₐₓ]} is covered.

The channel representation parameters can be defined as follows. Two alternatives can be devised:
(Alt 1) The main parameters are those which represent or are associated with the AoD parameters (θₘᵢₙ, θₘₐₓ, φₘᵢₙ, φₘₐₓ). For example, four parameters—each representing one of those four DL AoD parameters—can be defined where each parameter represents an index to the AoD value.
   For example, in case of (1)-(7), these parameters are {k₀, K, l₀, L}.
   In addition to the four AoD parameters, a sub-sampling parameter may be defined and signaled to each UE. This sub-sampling parameter allows the eNB to configure each UE for a sparser subset selection. This is especially relevant when the master-set is heavily oversampled. For example, sub-sampling of 2 indicates that out of all the possible basis function indices in (4) or (7), only those corresponding to {k₀, k₀+2, . . . , K−2, K} and {l₀, l₀+2, . . . , L−2, l} are configured for the UE of interest.
(Alt 2) Alternatively, rather than signaling the DL AoD parameters and their companion parameters, it is also possible for the eNB to signal a parameter or a bitmap to each of the UEs which indicates the subset choice. For instance, if the master-set consists of 128 vectors, a 128-bit bitmap may be signaled to indicate the subset selection. If a restricted choice of subset is to be employed, the number of bits for representing the signaling parameter can be reduced.
   In case of the bitmap approach, two different bitmaps can be defined for φ and θ dimensions, respectively. Alternatively, a single two-dimensional bitmap for (φ,θ) can be used for better flexibility. This is especially applicable when the eNB configures a particular UE with a plurality of angular cones (as mentioned above).

The channel representation parameters can be signaled to by the eNB to each UE in several ways (including any combination of below):
(Alt 1) A higher-layer signaling (e.g., via RRC signaling) is used to update the quantization parameters per UE.
(Alt 2) D-BCH signaling in LTE is able to accommodate such (quantization parameters slowly updated). The quantization parameters are signaled via PDSCH where the UE of interest is notified via some paging mechanism (e.g. PDCCH-based) to look for the update.
(Alt 3) When aperiodic PUSCH-based (shared data channel) CSI reporting (e.g. in TS36.213 section 7.2.1) is configured for the UE, the quantization parameters can be included in the UL grant that triggers the CSI report.

### Embodiment 3

Starting from either embodiment 1 or 2, another level of reduction in dimensionality may be achieved if the channel representations in (1)/(1b) or (5) is applied to the channel eigenvectors rather than the channel itself. Using (1b) to illustrate the method (which should be readily extended to the case with (1) or (5) by those skilled in the art), the procedure is as follows:
Eigen-decomposition or singular-value decomposition is performed to the DL MIMO channel for each polarization and frequency subband. Here the channels associated with different receive antennas are concatenated into one channel matrix.
Based on the chosen RI (for example, either N=1 or 2), the UE selects N dominant (strongest) eigenvectors (or the right singular vectors) and the corresponding eigenvalues are reflected/captured in the N CQI values that are reported along with the RI.
Since the UE is situated within one or a few small angular cones, each of the N eigenvectors (for each polarization and frequency sub-band) allows the following approximation (cf. equation (1b)).

v^{(f)}≅Σ_{(k,l)εΩ}d_{k,l}^{(f)}vec{A(φₖ,θₗ)} (7b)

Here vec{X} converts the matrix X into a vector by stacking all the column vectors of X.
For each of the N eigenvectors, the coefficients d_{k,l}^{(f)} are then quantized by the UE and reported to the eNB.
Once eNB receives the report from the UE, eNB reconstructs each of the N eigenvectors according to (7b).

In general, this embodiment captures the UE feedback and eNB reconstruction of N quantized precoding vectors for N transmission layers, where each of the N precoding vectors (with a special case of N=1 or 2) is quantized according to the channel representation in (1)/(1b) or (5) as embodied in (7b). The associated CQI value(s) correspond to the value of RI and the choice of the N precoding vectors. The above embodiment where the precoding vectors are eigenvectors is merely exemplary.

For all the aforementioned embodiments (1, 2, and 3), a quantization scheme is needed. Given the above channel representation parameters, the coefficients

$$\{ {c}_{k , l}^{( q , f )} \}$$

are to be computed by the UE (see below for details), then those coefficients are quantized at the UE based on a predetermined method/procedure (which needs to be specified). Different quantization procedures (either scalar or vector quantization) can be used to efficiently “compress” the coefficient feedback to the eNB.

The quantization of coefficients

$$\{ {c}_{k , l}^{( q , f )} \}$$

requires a quantization codebook C, which may be constructed to minimize a metric such as (8) below or to minimize codebook search time or to exploit the dependencies between samples to be quantized or to meet any other design criterion. A few exemplary codebook design considerations and alternatives are provided below. Those skilled in the art will recognize that any other codebook alternatives are also within the scope of this disclosure.
Since the coefficients

$$\{ {c}_{k , l}^{( q , f )} \}$$

are complex, first the real and imaginary parts may be separated, and then scalar quantized using the same or two different scalar codebooks. The scalar codebooks may be uniform or non-uniform in (rₗ, rₕ) where rₗ<rₕ are real numbers.
Alternatively, the real and imaginary parts of coefficients may first be separated, then vectorized in vectors of fixed length N, and finally vector quantized using vector codebooks. The vector codebooks may be uniform or non-uniform in an N-dimensional region in Euclidean space.
   In one design, the vector codebooks are different for real and imaginary components.
   In another design, the same vector codebook is used for both real and imaginary components.
      In one vectorization method, the vectors consist of either all real or all imaginary components of coefficients.
      In another vectorization method, the vectors consist of both real and imaginary components of coefficients. For example, the real and imaginary components of the same coefficient are placed next to each other either in the same vector or in two adjacent vectors (real component is the last element of the vector and imaginary component is the first element of the adjacent vector).
      In another vectorization method, the real and imaginary components are placed according to a pre-defined permutation.
Alternatively, the amplitudes and phases of the coefficients may be quantized using amplitude and phase codebooks, respectively.
   The amplitude codebook may be a scalar codebook where the amplitude of each coefficient is quantized separately. The amplitude codebook may be uniform or non-uniform in (aₗ, aₕ) where 0≦aₗ<aₕ are positive numbers.
   Alternatively, it may be a vector codebook where we first vectorize amplitudes (of fixed length N) of all coefficients and then quantize them using a vector amplitude codebook, which may be uniform or non-uniform in an N-dimensional region in positive orthant.
   The phase codebook may be uniform or nonuniform in (aₗ, aₕ) where 0≦αₗ<αₕ≦2π.
In above-mentioned or other codebook designs, the vectorization and quantization at the UE and the reconstruction and de-vectorization (extracting real and imaginary components) at the eNB must be aligned.
Since different vectorization and quantization methods will result in different codebooks, the vectorization and quantization methods may be configurable by eNB and the configuration may be signaled to the UE together with the channel representation parameter signaling (see above). Depending on the configured vectorization and quantization methods, the UE vectorizes the coefficients and uses the corresponding codebook to quantize the vectors.
The designed codebook may be basis-agnostic or basis-aware. If it is basis-agnostic, then it is desired to design one codebook that is universally applicable to all UEs regardless of their configured basis (A(φₖ, θₗ) or B_{k,l}). If it is basis-aware, then codebook design may be specific to the basis and may change from basis to basis.
In some designs, the codebook may be fixed and non-adaptive over time, and it may be designed once based on some channel statistics such as second moments. In other designs, it may be adaptive over time, and hence updated periodically or aperiodically based on real channel measurements. This codebook adaptation may be configurable by the eNB together with the channel representation parameter signaling (see above) or separately.
In some designs, the codebook may be non-adaptive (pre-determined) but only a subset of the codebook is used for a given DL channel coefficient quantization. In this case, different subsets of the codebook are used by the UE of interest across consecutive quantizations (and reporting instances). Upon receiving the feedback, the eNB may take into account reports over multiple instances to derive a higher resolution representation of the corresponding DL MIMO channel. For example, a linear filtering may be performed at the eNB across multiple reporting instances. Since different subsets are used across multiple reporting instances, feedback overhead can be reduced for a given desirable resolution. It also allows the eNB to reconstruct and update the DL MIMO channel coefficients at the highest possible reporting rate.
The channel coefficient computation and quantization may be performed separately in which channel coefficients are computed first, for example according to (9) below, and then the computed channel coefficients (ĉ^{(q,f)}) are quantized. Alternatively, the quantized channel coefficients are directly obtained, for example using the codebook in place c_{k,l}^{(g,f)} in (8).
If the UE's channel resides in multiple cones, i.e., a set of AoD parameters {(θₘᵢₙ, θₘₐₓ, φₘᵢₙ, φₘₐₓ)}, then the channel coefficient quantization and feedback may be joint or it may be cone-specific.

A few example codebook choices are provided below. The details of their design are skipped and are available in literature.

Scalar Gaussian Codebook:

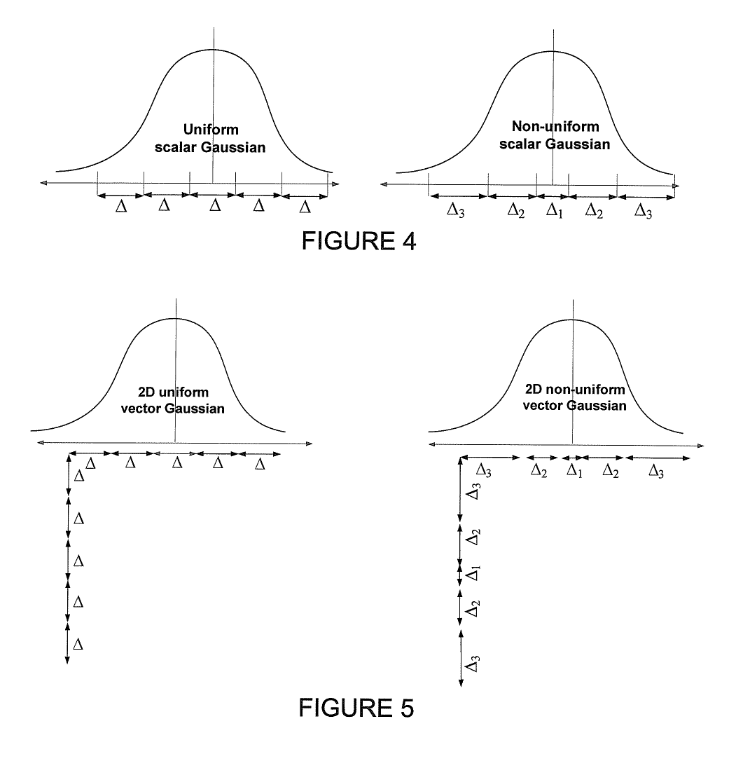

Assuming independent and identically distributed standard normal channel coefficients, the designed scalar codebook (see FIG. 4) may be:
uniform, in which case the quantization points are uniformly spaced (Δ) on the real line, or
non-uniform, in which case the quantization points are non-uniformly spaced (Δ₁, Δ₂, Δ₃, . . . ) on the real line.
   Before quantizing the channel coefficients using scalar Gaussian codebook, the channel coefficients are normalized by the estimated channel variance. The quantized value of the estimated channel variance is also fed back to the eNB together with the quantized channel coefficients. The eNB uses both of them to reconstruct the channel coefficients.

Vector Gaussian Codebook:

Assuming independent and identically distributed standard normal channel coefficients, the designed vector codebook (see 2D example in FIG. 5) may be:
uniform, in which case the quantization points are uniformly spaced (Δ) in N-dimensional Euclidean space, or
non-uniform in which the quantization points are non-uniformly spaced (Δ₁, Δ₂, Δ₃, . . . ) in N-dimensional Euclidean space.
   Before quantizing the channel coefficients using vector Gaussian codebook, the vectorized channel coefficients are pre-multiplied by the negative square root of estimated channel covariance matrix. The quantized value of the estimated channel covariance is also fed back to the eNB together with the quantized channel coefficients. The eNB uses both of them to reconstruct the channel coefficients.

Training-Based Codebook:

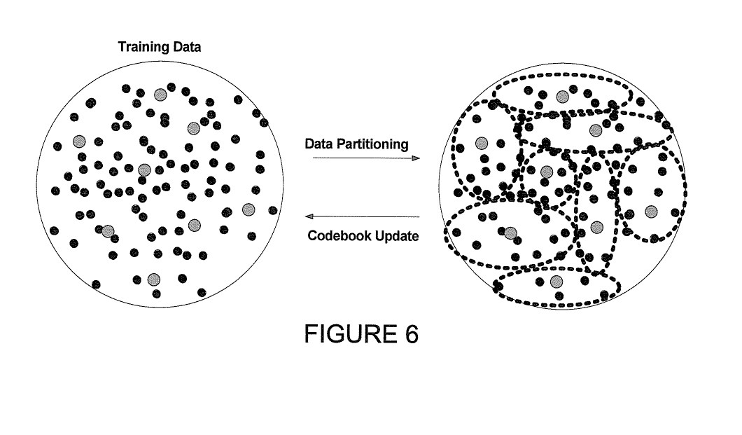

In some designs, the codebook construction may be training-based using actual channel measurements. A few example training-based codebooks are as follows.
Iterative Lloyd-Max codebook: The algorithm starts with the initial codebook selection, for example from the training data (scalar or vector). This is followed by data partitioning using the initial codebook based on some metric such as minimum distance. The codebook is then updated using the partitioned data, for example, the updated code points may be the centroid of the partitions. The algorithm continues to iterate until some stopping criterion is met. An illustration of the Lloyd-Max algorithms is provided in FIG. 6.
Shape-gain codebook: If the dynamic range of the channel coefficients is large, then the magnitude (gain) and the direction (shape) of data vectors may be separately quantized. The gain codebook is scalar codebook and the shape codebook is a vector codebook, both can be designed using the Lloyd-Max algorithm.
Structured codebook: In order to reduce the codebook search complexity (especially for vector codebooks), the codebook may be multi-level and structured such that the lower level codebooks are smaller than the upper level codebooks and they partition the upper level codebooks uniformly. The codebook search starts at the lower levels, and the “best” codewords in the lower levels are used to restrict the codebook search in upper level codebooks. Such structured codebooks can also be designed using the Lloyd-Max algorithm.

Basis-Aware:

The codebook construction can be basis-aware the basis information is included while designing the codebook.

UE and eNB Procedures

As mentioned above, the UE is to report the quantized channel coefficients

$$\{ {c}_{k , l}^{( q , f )} \}$$

to the eNB. While LTE (or any wireless standard) specifications do not typically specify how channel coefficients are computed, those channel coefficients are typically computed to minimize some type of error measure for the representation given either in the first or the second embodiment in the exemplary embodiments described above. One possibility is to use the following least-square error criterion:

$${min}_{\{ {H}_{k , l}^{( q , f )} \}} {‖ {H}^{( q , f )} - {\sum }_{k = {k}_{0}}^{{k}_{0} + K - 1} {\sum }_{l = {l}_{0}}^{{l}_{0} + L - 1} {c}_{k , l}^{( q , f )} {B}_{k , l} ‖}_{F}^{2} \qquad ( 8 )$$

Note that the above example (8) assumes the representation associated with embodiment 2 given in (5). Those who are skilled in the art should be able to see a straightforward extension to embodiment 1 given in (1).

In case of multiple-cone configuration, equation (8) may be applied to each of the plurality of cones.

Given an estimate of H^{(q,f)} derived by the UE (e.g., through some channel estimation), the UE may compute the least-square solution of (8) as follows:

$${\hat{c}}^{( q , f )} = {( {Σ}^{( q , f ) H} {Σ}^{( q , f )} )}^{- 1} {Σ}^{( q , f ) {H}_{{h}^{( q , f )}}} \\ {\hat{c}}^{( q , f )} = [ \begin{matrix}{c}_{{k}_{0} , {l}_{0}}^{( q , f )} \\ ⋮ \\ {c}_{{k}_{0} , {l}_{0} + L - 1}^{( q , f )} \\ ⋮ \\ {c}_{{k}_{0 + K - 1} , {l}_{0}}^{( q , f )} \\ ⋮ \\ {c}_{{k}_{0} + k - 1 , {l}_{0} + L - 1}^{( q , f )}\end{matrix} ] , {h}^{( q , f )} = vec [ {H}^{( q , f )} ] , \\ {Σ}^{( q , f )} = [ vec \{ {B}_{{k}_{0} , {l}_{0}} \} … vec \{ {B}_{{k}_{0} , {l}_{0} + L - 1} \} … vec \{ {B}_{{k}_{0} + K - 1 , {l}_{0}} \} … vec \{ {B}_{{k}_{0} + K - 1 , {l}_{0} + L - 1} \} ] \qquad ( 9 )$$

Here vec{X} converts the matrix X into a vector by stacking all the column vectors of X. As mentioned above, the number of expansion coefficients in h^{(q,f)}(KL) is chosen to be significantly less than NᵣN_{c} (the original number of channel coefficients) which results in reduction in dimensionality.

Once the eNB receives and decodes the feedback of

$$\{ {C}_{k , l}^{( q , f )} \}$$

from the UE, the eNB may reconstruct the DL MIMO channel according to the representation equation in (5) (or in (1) for embodiment 1). Then the eNB may perform link adaptation (including precoding) and scheduling (including MU-MIMO) based on the reconstructed DL MIMO channel from each UE.

### CSI-RS Issue

To obtain an estimate of H^{(q,f)}, the UE may use different types of reference signals (RS). Among the available reference signals in LTE (CRS, CSI-RS, DM-RS, locationing/positioning RS, discovery RS), CSI-RS seems to be the best candidate for the proposed scheme. In this case, the eNB configures a set of CSI-RS resources for the antenna ports associated with each UE. Since CSI-RS resources could be rare, the eNB may utilize a resource reduction technique to send CSI-RS (to cover all the necessary antenna ports) which can be done in time and/or spatial domain. In that case, the UE may perform interpolation to recover all the necessary MIMO channel coefficients H^{(q,f)}.

Joint Operation: Two Examples

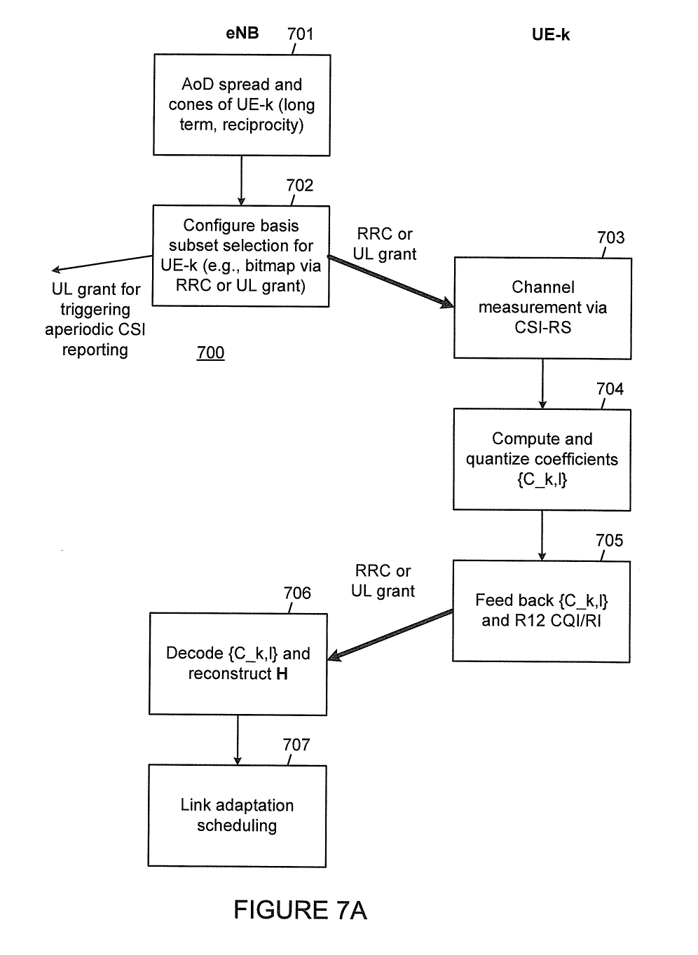

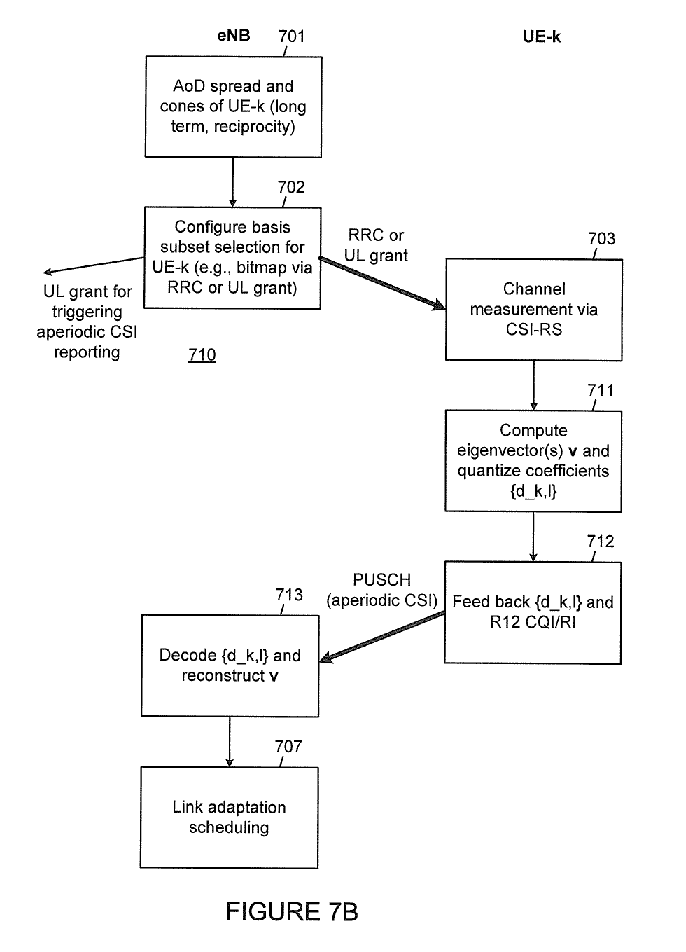

FIGS. 7A and 7B illustrate two exemplary operations of the above-proposed scheme. Here, operation refers to overall transmit-receive operations at the eNB and the UE. FIG. 7A exemplifies channel quantization 700 whereas FIG. 7B exemplifies eigenvector quantization 710. In either case, the eNB measures the DL AoD profile for UE-k (including the AoD spread) from at least one uplink signal (step 701). Based on that measurement, the eNB performs a basis subset selection for UE-k from a fixe predetermined master-set of basis vectors/matrices (step 702). This common master-set is pre-known at the eNB and all UEs. Once the subset is selected, the selection is signaled to UE-k (either via higher layer signaling or a UL grant).

Upon receiving and successfully decoding the configuration parameter (that informs UE-k of its basis subset) and measuring the associated DL channel from CSI-RS (step 703), UE-k responds by computing the basis expansion coefficients relative to the configured basis subset (step 704 or step 711). These coefficients are then quantized according to a predetermined quantization scheme (step 704 or step 711), and fed back to the eNB via an uplink channel (step 705 or step 712).

Upon receiving feedback from UE-k (as well as from other UEs), the eNB reconstructs either the channel or the eigenvector (step 706 or step 713). This is used for link adaptation and scheduling (step 707).

Other Variations

DL Interference Information

The above discussion assumes quantization of the DL MIMO channel H^{(q,f)}. For DL link adaptation and scheduling, the eNB requires not only the DL MIMO channel, but also the DL interference profile seen by the associated UE. Since the UE is able to derive a DL interference estimation (e.g., interference covariance matrix, interference power), the UE may report the quantized coefficients

$$\{ {C}_{k , l}^{( q , f )} \}$$

derived from the pre-whitened estimate of the DL MIMO channel H^{(g,f)} (or in general, the DL MIMO channel estimate properly scaled by the DL interference estimate). For instance, if the DL interference covariance matrix estimate for a given polarization, receive antenna, and subband is R^{(q,f)}, the DL channel coefficient computation in (9) is performed based on (R^{(q,f)})^{-1/2}H^{(q,f)} rather than simply H^{(q,f)}.

In case of FD-MIMO, it is expected that the DL interference profile seen by each UE may be wideband (rather than frequency selective) due to the narrow beam which the eNB applies to the UE. In that case, R^{(g,f)} may simply be σ^{(q,f)2}. Hence, pre-whitening is reduced to a scalar multiplication which can be done after the coefficient computation in (9) is done. That is, the UE will simply report/feedback

$$\{ \frac{{C}_{k , l}^{( q , f )}}{{σ}^{( q , f )}} \}$$

to the eNB.

Concurrent Operation with Rel.12 CSI Reporting

While the proposed explicit channel feedback facilitates full link adaptation and scheduling at the eNB, it may be beneficial to operate it in conjunction with Rel.12 CSI reporting. Some reasons are as follows:
Concurrent operation with Rel.12 CSI may simplify testing (performance requirements or inter-operability)
Rel.12 CSI may be used to at least convey DL interference information and/or any relevant scaling factor

In this case, the eNB configures the UE of interest with two reporting schemes: 1) DL channel feedback as described above, and 2) Rel.12 CSI feedback schemes (e.g., one periodic PUCCH-based and one aperiodic PUSCH-based). The following exemplary embodiments are possible.
With periodic PUCCH-based reporting. In conjunction with explicit DL channel feedback, a periodic CSI reporting is configured. Two possibilities exist:
   Without PMI (mode 1-0 or 2-0): Here RI signals a recommended transmission rank to the eNB (assuming a single-user transmission). CQI may indicate a recommended spectral efficiency (modulation and coding scheme, or “MCS”) assuming a given precoding at the eNB with a single-user transmission). This given precoding may either be a fixed precoding vector/matrix or a maximum ratio transmission (MRT) precoding vector/matrix.
      Once the eNB receives this report along with the quantized DL channel, the eNB may infer the interference level experienced by the UE (whether it is wideband for 1-0 or narrowband for 2-0).
      It is also possible for the eNB to restrict RI to either 1 or 2—either based on other configuration parameter(s) or the Rel.12 codebook subset restriction feature.
   With PMI (mode 1-1 or 2-1): When PMI is included, a reference to the existing Rel.12 precoding codebooks (2-, 4-, or 8-antenna port codebooks) is used. Essentially, PMI is an index to a precoding matrix within a codebook. When the number of antenna ports associated with FD-MIMO is larger than 8 (which is most likely the case), the reported PMI may be utilized to signal a recommended precoding matrix/vector associated with the horizontal antenna array dimension (which does not exceed 8 due to the limitation of Rel.12 precoding codebooks, see FIG. 1). This PMI assumes a single-user transmission. CQI/RI is used with reference to the PMI.
      Once the eNB receives this report along with the quantized DL channel, the eNB may infer the interference level experienced by the UE (whether it is wideband for 1-1 or narrowband for 2-1).
      It is also possible for the eNB to restrict RI to either 1 or 2—either based on other configuration parameter(s) or the Rel.12 codebook subset restriction feature.
With aperiodic PUSCH-based reporting. In conjunction with explicit DL channel feedback, an aperiodic CSI reporting is configured. Similar to the periodic reporting, two possibilities exist:
   Without PMI (mode 1-0, 2-0, or 3-0): Here RI signals a recommended transmission rank to the eNB (assuming a single-user transmission). CQI may indicate a recommended spectral efficiency (MCS) assuming a given precoding at the eNB with a single-user transmission). This given precoding may either be a fixed precoding vector/matrix or a maximum ratio transmission (MRT) precoding vector/matrix.
      Once the eNB receives this report along with the quantized DL channel, the eNB may infer the relative interference level experienced by the UE (whether it is wideband for 1-0 or narrowband for 2-0/3-0).
      It is also possible for the eNB to restrict RI to either 1 or 2—either based on other configuration parameter(s) or the codebook subset restriction feature.
   With PMI (mode 1-2, 2-1, 3-1, or 3-2): When PMI is included, a reference to the existing Rel.12 precoding codebooks (2-, 4-, or 8-antenna port codebooks) is used. Essentially, PMI is an index to a precoding matrix within a codebook. When the number of antenna ports associated with FD-MIMO is larger than 8 (which is most likely the case), the reported PMI may be utilized to signal a recommended precoding matrix/vector associated with the horizontal antenna array dimension (which does not exceed 8, see FIG. 1). This PMI assumes a single-user transmission. CQI/RI is used with reference to the PMI.
      Once the eNB receives this report along with the quantized DL channel, the eNB may infer the relative interference level experienced by the UE (whether it is wideband for 1-2 or narrowband for 2-1/3-1/3-2).
      It is also possible for the eNB to restrict RI to either 1 or 2—either based on other configuration parameter(s) or the codebook subset restriction feature.

Alternatively, the existing Rel.12 CSI reporting mechanism (modes) can be used to report primarily interference information (or in general, an indication of interference level) of the associated UE to the eNB. In this case, the CQI field may be used either to indicate a quantized interference power or to indicate a recommended MCS level (per Rel.12 CQI definition) assuming a pre-defined precoding (as discussed above) and/or transmission rank.

In addition to relying on the currently existing mechanism (as explained above), the explicit channel feedback contents may also be designed to include CQI/RI. As an example, consider a UE with 2 receive antennas (2-Rx)—although those skilled in the art will be able to extend the schemes below to any number of receive antennas.

In one method (CQURI reporting method 1), a 2-Rx UE is configured to report per-Rx-antenna quantized channel vector according to (1), and the UE reports the reconstructed channel matrix comprising two column (or row) vectors. The embodiments below are described in terms of column vectors only, but the same principle applies when the UE reports two row vectors of the reconstructed channel matrix.
In one example, a UE derives and reports rank-1 CQI, assuming that the eNB applies a precoder being equal to a strongest eigenvector (corresponding to the strongest of eigenvalues) of the reconstructed channel matrix.
In another example, a UE derives and reports rank-2 CQI, assuming that the eNB applies a precoder being equal to two eigenvectors of the reconstructed channel matrix.
In another example, a UE derives and reports rank-2 CQI, assuming that the eNB applies a precoder being equal to the reconstructed channel matrix comprising two columns.
In another example, a UE derives and reports rank-2 CQI, assuming that the eNB separately applies a precoder being equal to each column vector of the reconstructed channel matrix. In some embodiments, the UE derives a first CQI assuming that the eNB applies a precoder being equal to the first column vector; and a second CQI assuming a precoder being equal to the second column. In some embodiments, the UE derives a first CQI assuming that the UE processes a received signal on the first Rx antenna, wherein eNB applies a precoder for the received signal, the precoder being equal to the first column vector; the UE derives a second CQI in the same way with utilizing the second Rx antenna and the second column vector.
In some embodiments, UE may further assume, for CQI derivation purposes, that the eNB normalizes the power of each column vector of the reconstructed channel matrix to be one to use as a precoder.
In one alternative, the UE may derive and report RI and CQI jointly according to these examples.
In another alternative, the UE is configured to report only rank-2 CQI, so that the channel strength corresponding to 2-layer transmission is separately reported to the eNB.

In another method (CQI/RI reporting method 2), a 2-Rx UE is configured to report RI number of quantized channel vectors according to (1).
In one example, when RI=1 is reported, the UE is configured to quantize and report the eigenvector corresponding to the strongest eigenvalue of the full channel matrix according to (1), and corresponding CQI assuming that the eNB applies a precoder being equal to the aforementioned strongest eigenvector.
For CQI reporting when RI=2, embodiments related to CQI reporting method 1 can be used.

UE-Assisted Basis Subset Selection Via UE Feedback

The above examples assume that the eNB is able to measure the DL AoD profile from at least one UL signal due to long-term UL-DL channel reciprocity. This assumption is valid for most FDD deployment scenarios to date since the UL-DL duplex distance is relatively small.

For future systems, however, it is unclear whether such an assumption can be maintained, especially when UL and DL channels and cell radii may be asymmetric (which is reasonable since UL and DL traffics tend to be asymmetric). For instance, assigning a DL carrier in the mmWave region in conjunction with a UL carrier in the PCS band region is plausible. In such scenarios, even long-term UL-DL channel reciprocity cannot be maintained.

Therefore, an additional uplink feedback from a UE of interest to the eNB is beneficial to assist the eNB in performing basis subset selection. As previously mentioned, relevant DL AoD profile parameters may be measured at the UE and reported (fed back) to the eNB. Alternatively, the UE may report a recommended basis subset selection. For instance, a bitmap that represents a selection of basis vectors/matrices from a predetermined master-set (known at the eNB and all the UEs associated with the said eNB) is reported to the eNB.

One exemplary embodiment may be devised based on the Rel.12 specification. For illustrative purposes, only rank-1 and rank-2 (the most relevant scenarios for FD-MIMO) are discussed here, although it should be apparent to those skilled in the art how to extend these principles to higher ranks. TABLE 1 and TABLE 2 are codebooks defined in Rel.10/12 LTE specifications for rank-1 and rank-2 (1-layer and 2-layer) CSI reporting for UEs configured with 8 Tx antenna port transmissions. To determine a code word (CW) for each codebook, two indices, i.e., i₁ and i₂ have to be selected. In these precoder expressions, the following two variables are used:

φₙ=e^{jπn/2}

vₘ=[1 e^{j2πm/32} e^{j4πm/32} e^{j6πm/32]T}.

TABLE 1
Codebook for 2-layer CSI reporting using antenna ports 15 to 22

| | i₂ | | | | | | | |
|---|---|---|---|---|---|---|---|---|
| i₁ | 0 | 1 | 2 | 3 | 4 | 5 | 6 | 7 |
| 0-15 | W₂ᵢ_{₁}_{, 0}⁽¹⁾ | W₂ᵢ_{₁}_{, 1}⁽¹⁾ | W₂ᵢ_{₁}_{, 2}⁽¹⁾ | W₂ᵢ_{₁}_{, 3}⁽¹⁾ | W₂ᵢ_{₁}_{+1, 0}⁽¹⁾ | W₂ᵢ_{₁}_{+1, 1}⁽¹⁾ | W₂ᵢ_{₁}_{+1, 2}⁽¹⁾ | W₂ᵢ_{₁}_{+1, 3}⁽¹⁾ |
| | i₂ | | | | | | | |
| i₁ | 8 | 9 | 10 | 11 | 12 | 13 | 14 | 15 |
| 0-15 | W₂ᵢ_{₁}_{+2, 0}⁽¹⁾ | W₂ᵢ_{₁}_{+2, 1}⁽¹⁾ | W₂ᵢ_{₁}_{+2, 2}⁽¹⁾ | W₂ᵢ_{₁}_{+2, 3}⁽¹⁾ | W₂ᵢ_{₁}_{+3, 0}⁽¹⁾ | W₂ᵢ_{₁}_{+3, 1}⁽¹⁾ | W₂ᵢ_{₁}_{+3, 2}⁽¹⁾ | W₂ᵢ_{₁}_{+3, 3}⁽¹⁾ |

$where {W}_{m , n}^{( 1 )} = \frac{1}{\sqrt{8}} [ \begin{matrix}{v}_{m} \\ {ϕ}_{n} {v}_{m}\end{matrix} ]$

If the most recently reported RI=1, m and n are derived with the two indices i₁ and i₂ according to TABLE 1, resulting in a rank-1 precoder,

$${W}_{m , n}^{( 1 )} = \frac{1}{\sqrt{8}} [ \begin{matrix}{v}_{m} \\ {ϕ}_{n} {v}_{m}\end{matrix} ] .$$

TABLE 2
Codebook for 2-layer CSI reporting using antenna ports 15 to 22

| | i₂ | | | |
|---|---|---|---|---|
| i₁ | 0 | 1 | 2 | 3 |
| 0-15 | W₂ᵢ_{₁}_{, 2i}_{₁}_{, 0}⁽²⁾ | W₂ᵢ_{₁}_{, 2i}_{₁}_{, 1}⁽²⁾ | W₂ᵢ_{₁}_{+1, 2i}_{₁}_{+1, 0}⁽²⁾ | W₂ᵢ_{₁}_{+1, 2i}_{₁}_{+1, 0}⁽²⁾ |
| | i₂ | | | |
| i₁ | 4 | 5 | 6 | 7 |
| 0-15 | W₂ᵢ_{₁}_{+2, 2i}_{₁}_{+2, 0}⁽²⁾ | W₂ᵢ_{₁}_{+2, 2i}_{₁}_{+2, 1}⁽²⁾ | W₂ᵢ_{₁}_{+3, 2i}_{₁}_{+3, 0}⁽²⁾ | W₂ᵢ_{₁}_{+3, 2i}_{₁}_{+3, 0}⁽²⁾ |
| | i₂ | | | |
| i₁ | 8 | 9 | 10 | 11 |
| 0-15 | W₂ᵢ_{₁}_{, 2i}_{₁}_{+1, 0}⁽²⁾ | W₂ᵢ_{₁}_{, 2i}_{₁}_{+1, 1}⁽²⁾ | W₂ᵢ_{₁}_{+1, 2i}_{₁}_{+2, 0}⁽²⁾ | W₂ᵢ_{₁}_{+1, 2i}_{₁}_{+2, 0}⁽²⁾ |
| | i₂ | | | |
| i₁ | 12 | 13 | 14 | 15 |
| 0-15 | W₂ᵢ_{₁}_{, 2i}_{₁}_{+3, 0}⁽²⁾ | W₂ᵢ_{₁}_{, 2i}_{₁}_{+3, 1}⁽²⁾ | W₂ᵢ_{₁}_{+1, 2i}_{₁}_{+3, 0}⁽²⁾ | W₂ᵢ_{₁}_{+1, 2i}_{₁}_{+3, 0}⁽²⁾ |

$where {W}_{m , {m}^{′} , n}^{( 2 )} = \frac{1}{4} [ \begin{matrix}{v}_{m} & {v}_{{m}^{′}} \\ {ϕ}_{n} {v}_{m} & - {ϕ}_{n} {v}_{{m}^{′}}\end{matrix} ]$

If the most recently reported RI=2, m, m′ and n are derived with the two indices i₁ and i₂ according to TABLE 2, resulting in a rank-2 precoder,

$${W}_{m , {m}^{′} , n}^{( 2 )} = \frac{1}{4} [ \begin{matrix}{v}_{m} & {v}_{{m}^{′}} \\ {ϕ}_{n} {v}_{m} & - {ϕ}_{n} {v}_{{m}^{′}}\end{matrix} ] .$$

It is noted that W_{m,m′,n}⁽²⁾ is constructed such that it can be used for two different types of channel conditions that facilitate a rank-2 transmission.

One subset of the codebook associated with i₂={0, 1, . . . , 7} comprises codewords with m=m′, or with the same beams (vₘ) used for constructing the rank-2 precoder:

$${W}_{m , {m}^{′} , n}^{( 2 )} = \frac{1}{4} [ \begin{matrix}{v}_{m} & {v}_{m} \\ {ϕ}_{n} {v}_{m} & - {ϕ}_{n} {v}_{m}\end{matrix} ] .$$

In this case, the two columns in the 2-layer precoder are orthogonal (i.e., [vₘ φₙvₘ]^{H}·[vₘ−φₙvₘ]=0), owing to the different signs applied to φₙ for the two columns. These rank-2 precoders are likely to be used for those UEs that can receive strong signals along two orthogonal channels generated by the two differently polarized antennas.

The UE operation according to some embodiments of the current invention is as follows (assuming the use of 2D antenna array):
1. UE receives CSI-RS configuration for N_{P} antenna ports and corresponding CSI-RS.
   a. N_{P} may be decomposed into N_{P}=N_{H}·N_{V}, where N_{H} is a number of antenna ports along one row and N_{V} is a number of antenna ports along one column of 2D rectangular antenna array. In one example, N_{V}=4 and N_{H}=8, wherein the cross-polarized (“x-pol”) dimension is counted within a row rather than a column.
2. Processing the CSI-RS, the UE derives CQI, PMI, RI, wherein
   a. RI corresponds to a preferred or recommended rank by the UE; and
   b. PMI corresponds to a preferred or recommended precoding matrix by the UE, each column of which, say w, is constructed with a linear combination of a number of basis vectors:

$$w = {\sum }_{l = 1}^{L} {c}_{l} {a}_{l} .$$

i. {aₗ} is a set of basis vectors comprising L distinct basis vectors selected out of a mother or master set comprising a large number (>>L) of basis vectors, and each basis vector aₗ is an N_{P}×1 vector.
   a) aₗ can be further decomposed into: aₗ=hₗ [symbol] vₗ, wherein hₗ and vₗ are DFT vectors of size N_{H}×1 and N_{V}×1 respectively representing azimuth and elevation array responses for a given pair of azimuth and elevation angles. In this case, the master-set may be constructed as a product set: {hₗ [symbol] vₗ: hεW_{H}, vεW_{V}}.
   1) In one example, L=4. Furthermore, vₗ=v, ∀l, wherein vεW_{V}; and H={hₗ}_{l=1,2,3,4} corresponds to four beams corresponding to i₁ in LTE Rel-10 8-Tx codebook (TABLE 1 and TABLE 2), i.e., H={v₂ᵢ, v₂ᵢ₊₁, v₂ᵢ₊₂, v₂ᵢ₊₃}, where
   vₘ=[1 e^{j2πm/32} e^{j4πm/32} e^{j6πm/32}]^{T}.
   b) aₗ can be further decomposed into:

$${a}_{l} = [ \begin{matrix}{h}_{l} \\ {e}^{{jϕ}_{l}} {h}_{l}\end{matrix} ] ⊗ {v}_{l}$$

where h₁ and v₁ are DFT vectors of size N_{H}×1 and N_{V}×1 respectively representing azimuth and elevation array responses for a given pair of an azimuth angle and an elevation angle; and

$${ϕ}_{l} ∈ \{ \frac{2 m π}{M} \text{:} \begin{matrix}m can be selected from a \\ set of nonnegative integers\end{matrix} \}$$

represents the co-phase of the x-pol array. In this case, the mother set can be a product set:

$$\{ [ \begin{matrix}{h}_{l} \\ {e}^{{jϕ}_{l}} {h}_{l}\end{matrix} ] ⊗ {v}_{l} ⊗ v \text{:} h ∈ {W}_{H} , v ∈ {W}_{V} \} .$$

c) For example, a DFT vector of size 4×1 is vₘ=[1 e^{j2πm/D} e^{j4πm/D} e^{j6πm/D}]^{T}, where D=2ⁿ and n is a positive integer. Other size DFT vectors can be similarly constructed.
ii. {cₗ} is a corresponding set of L scaling coefficients, each element of which is a complex number. Some alternatives for cₗ quantization are:
   a) Real and imaginary components of cₗ are separately quantized, N_{Re} quantization bits for the real dimension and N_{Im} quantization bits for the imaginary dimension.
   1) In one method, N_{Re}=N_{Im}
   b) Amplitude and phase components of cₗ are separately quantized, N_{A} quantization bits for the amplitude and N_{Ph} quantization bits for the phase.
   c) Some details for the quantization methods can be found above.
c. CQI corresponds to a modulation and coding scheme which allows the UE to receive a PDSCH packet with a constant (e.g., 0.1) packet error probability when the selected PMI and the selected RI is used for precoding.
d. UE may select RI and PMI that allows the best (or highest) CQI for the PDSCH transmission with a constant (e.g., 0.1) error probability.
3. The UE report PMI/CQI/RI on a single PUSCH, when triggered for an aperiodic (PUSCH) report:
   a. In one method, PMI corresponding to a basis vector set {aₗ} is wideband (i.e., only one set is reported in the aperiodic report), the PMI corresponding to the coefficient set {cₗ} is subband (i.e., multiple sets, e.g., one per subband are reported in the periodic report).
4. The UE report CQI/PMI on a PUCCH in another subframe with a period P, RI on a PUCCH in one subframe with a period Q, when configured with a periodic report.
5. In one method, PMI corresponding to a basis vector set is less frequently reported (i.e., reported with larger period) than the PMI corresponding to the coefficient set.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A user equipment, comprising:
a receiver configured to receive signals from a plurality of transmit antenna elements within a two-dimensional antenna array at a base station, and to receive an indication of a subset selection of vectors;
a processor configured to determine channel state information (CSI) for a downlink (DL) multiple input multiple output (MIMO) channel between the user equipment and the two-dimensional antenna array, the CSI corresponding to a subset of vectors that is based upon the received indication of the subset selection; and
a transmitter configured to transmit an indication of the CSI to the base station.

2. The user equipment according to claim 1, wherein the subset selection indication is transmitted to the user equipment via higher layer signaling.

3. The user equipment according to claim 1, wherein the subset selection indication is contained in an uplink grant for the user equipment.

4. The user equipment according to claim 1, wherein the CSI comprises a plurality of channel coefficients, where each coefficient corresponds to one vector in the subset selected by the base station and is computed in response to a downlink channel measurement.

5. The user equipment according to claim 4, wherein the user equipment also reports an indication associated with a recommended subset selection to the base station.

6. A method, comprising:
receiving at a user equipment signals from a plurality of transmit antenna elements within a two-dimensional antenna array at a base station;
receiving at the user equipment an indication of a plurality of subset selection of vectors;
determining at the user equipment channel state information (CSI) for a downlink (DL) multiple input multiple output (MIMO) channel between the user equipment and the two-dimensional antenna array, the CSI corresponding to a subset of vectors that is based upon the received indication of the subset selection; and
transmitting from the user equipment an indication of the CSI to the base station.

7. The method according to claim 6, wherein the subset selection indication is transmitted to the user equipment via higher layer signaling.

8. The method according to claim 6, wherein the subset selection indication is contained in an uplink grant for the user equipment.

9. The method according to claim 6, wherein the CSI comprises a plurality of channel coefficients, where each coefficient corresponds to one vector in the subset selected by the base station and is computed in response to a downlink channel measurement.

10. The method according to claim 9, wherein the user equipment also reports an indication associated with a recommended subset selection to the base station.

11. A base station, comprising:
a unit configured to select a subset of a master codebook for at least one user equipment, wherein the master codebook consists of a plurality of precoders;
a transmitter configured to signal the subset selection to the user equipment via a downlink channel;
a receiver configured to decode at least one type of channel state information (CSI) report from the user equipment; and
a unit configured to reconstruct channel information for the user equipment from the decoded CSI report and a linear combination of the precoders in the selected subset.

12. The base station according to claim 11, wherein the subset is chosen based on at least an angle-of-arrival profile measured from at least one uplink signal.

13. The base station according to claim 12, wherein the angle-of-arrival profile consists of a range of azimuthal angles and a range of elevation angles.

14. The base station according to claim 11, wherein the subset is chosen based on at least a second type of CSI report.

15. The base station according to claim 14, wherein the second type of CSI report is reported at a different periodicity from the first type of CSI report.

16. A method, comprising:
selecting a subset of a master codebook for at least one user equipment, wherein the master codebook consists of a plurality of precoders;
signaling the subset selection to the user equipment via a downlink channel;
decoding at least one type of channel state information (CSI) report from the user equipment; and
reconstructing channel information for the user equipment from the decoded CSI report and a linear combination of the precoders in the selected subset.

17. The method according to claim 16, wherein the subset is chosen based on at least an angle-of-arrival profile measured from at least one uplink signal.

18. The method according to claim 17, wherein the angle-of-arrival profile consists of a range of azimuthal angles and a range of elevation angles.

19. The method according to claim 16, wherein the subset is chosen based on at least a second type of CSI report.

20. The method according to claim 19, wherein the second type of CSI report is reported at a different periodicity from the first type of CSI report.
